(19) United States
(12) Patent Application Publication
(10) Pub. No.: US 2010/0050715 A1
(43) Pub. Date: Mar. 4, 2010

(54) Magnetic coded lock mechanism

(76) Inventors: Ming Xing Hu, Nanchang (CN); Nan Zhou, Derwood, MD (US)

Correspondence Address: Nan Zhou, 7508 Quincewood Court, Derwood, MD, 20855, US

(21) Appl. No.: 12/198,855

(22) Filed: Aug. 26, 2008

(51) Int. Cl. E05B 47/00; E05B 29/14

(52) U.S. Cl. 70/356; 70/413

(57) ABSTRACT

A magnetic coded lock mechanism which includes a key having a plurality of recesses and a plurality of permanent magnets properly coded around the key body, a cylindrical plug having a keyway aperture, a plurality of main apertures as passages, which contain movable key pins, a plurality of auxiliary apertures as magnetic locking passages corresponding to coded key, which contain movable magnets, a plurality of fixed magnets coded around the cylindrical plug as the way for biasing the magnets and locking pins toward the keyway, and a stationary tubular cylinder having a longitudinal aperture disposed in the center for receiving the cylindrical plug, a plurality of radial main apertures as passages for mating with the main apertures of the cylindrical plug, each passage containing a driver pin with a coil spring, and radial auxiliary apertures as passages for mating with the auxiliary apertures of the cylindrical plug, each passage containing a locking pin, whereby in a locked position, the driver pins and locking pins straddle both passages to prevent relative movement between the cylindrical plug and the tubular cylinder, and in an unlocked position, when the key is insert into the keyway, the key recesses drive the key pins in the main apertures of the cylindrical plug to a predetermined level and the movable magnets in auxiliary apertures of the cylindrical plug are repelled radially outward along the passages to a predetermined level respectively, so as to cause unlocking of the magnetic lock mechanism.

### CROSS-REFERENCE TO RELATED APPLICATIONS

### References Cited

### U.S. Patent Documents

| | | |
|---|---|---|
| 2648729 | August 1953 | Noregaard |
| 3416336 | December 1968 | Felson |
| 3512382 | May 1970 | Check et al. |
| 3,942,345 | Mar. 9, 1976 | Sasahara |
| 4,026,134 | May 31, 1977 | Woolfson |
| 4,476,701 | Oct. 16, 1984 | Herriott |
| 5,074,136 | Dec. 24, 1991 | Kim, et al. |
| 6,041,628 | Mar. 28, 2000 | Lin |
| 6,705,139 | Mar. 16, 2004 | Tsai |

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACE DISC

Not Applicable

### FIELD OF THE INVENTION

This invention relates to locks and particularly to magnetic coded locks, which combines a conventional pin-tumbler lock with a magnetic pin lock mechanism to provide more locking permutations and combinations, is highly resistant to lock-picking and lock-bumping and also incorporates strict key control measures.

### BACKGROUND OF THE INVENTION

The conventional pin-tumbler locking mechanisms are subject to tampering, resulting from unauthorized key duplications, lock-picking and lock-bumping. Lock-bumping is an especially serious security risk that has jumped in occurrence due to its limited mechanical structure and theory. Although many types of magnetically actuated or controlled locking mechanisms are known in arts, they all bear a common drawback of failing to ensure that all magnetic tumblers precisely returning to their locking position when the key is withdrawn from the keyway. In addition to the reliability of magnetically actuated locks, most of these locks are complicated in construction and expensive to manufacture. These types of unresolved problems have prevented the magnetic locks from being commonly sold in the consumer market and being broadly utilized by these consumers.

### SUMMARY OF THE INVENTION

The primary object of the present invention is to provide a magnetic coded lock mechanism, which is a combination of pin-tumbler lock and magnetic pin lock to overcome the above problems of conventional locking mechanism.

Another object of the present invention is to provide a locking mechanism, which is simple in construction and inexpensive to manufacture.

A further object of the present invention is to provide a locking mechanism capable of anti-picking, anti-bumping and key control to improve security.

Additionally, another object of the present invention to use a stationary permanent magnet instead of a coil spring to retract the reciprocal magnetic locking pin back to the original position when the key withdraws from the lock, which eliminates mechanical failure.

In order to accomplish these above objects, the present invention provides a magnetic coded key lock mechanism, which comprises a non-magnetic metal key having a plurality of recesses and a plurality of permanent magnets properly coded around the key body, a cylindrical plug having a keyway aperture, a plurality of main apertures as passages which contain key pins, a plurality of auxiliary apertures as magnetic locking passages corresponding to the coded key, which contains movable magnets, a plurality of fixed magnets coded around the cylindrical plug as the means for biasing the magnets and locking pins toward the keyway, and a stationary tubular cylinder having a longitudinal aperture disposed in the center for receiving cylindrical plug, a plurality of radial main apertures as passages for mating with the main apertures of the cylindrical plug, each passage contains a driver pin with a coil spring, and radial auxiliary apertures as passages for mating with the auxiliary apertures of the cylindrical plug, each passage contains a locking pin, whereby in a locked position, the driver pins and locking pins straddle both in the passages to prevent relative movement between the cylindrical plug and the tubular cylinder, and in an unlocked position, when the key is insert into the keyway, the key recesses drive key pins in main apertures of the cylindrical plug to a predetermined level and the movable magnets in auxiliary apertures of the cylindrical plug are repelled radially outward along the passages to a predetermined level respectively, so that all key pins and driver pins as well as moveable magnets and locking pings are separated at the shear plane between cylindrical plug and tubular cylinder. Thus, the magnetic lock mechanism is unlocked. When the key withdraws, key pins are returned to the original positions driven by spring force and the locking pins are retracted back to the cylindrical plug by the biasing force produced by fixed permanent magnets in cylindrical plug.

### BRIEF DESCRIPTION OF THE DRAWINGS

The present invention will be better understood from the detailed description given below and the accompanying drawings which are given by way of illustration only, and thus are not limitative of the present invention, and wherein;

FIG. 1 is a main view of the lock mechanism according to the present invention;

FIG. 2 is a sectional view of the lock mechanism in locked position according to the present invention;

FIG. 3 is a sectional view of the lock mechanism in locked position with the key inserted according to the present invention;

FIG. 4 is a sectional view of the lock mechanism with the key inserted and turned at a small angle according to the present invention.

### REFERENCE NUMERALS IN DRAWINGS

1 auxiliary aperture cover

2 coil spring

3 driver pin

4 key pin

5 fixed permanent magnets

6 permanent magnets inside key

7 magnetic coded key

8 stationary tubular cylinder

9 cylindrical plug

10 radial aperture cover

11 movable permanent magnets

12 locking pin

13 keyway

14 outer surface of plug

15 inner surface of tubular cylinder

17 main aperture

18 auxiliary aperture

### DETAILED DESCRIPTION OF THE PREFERRED EMBODIMENT

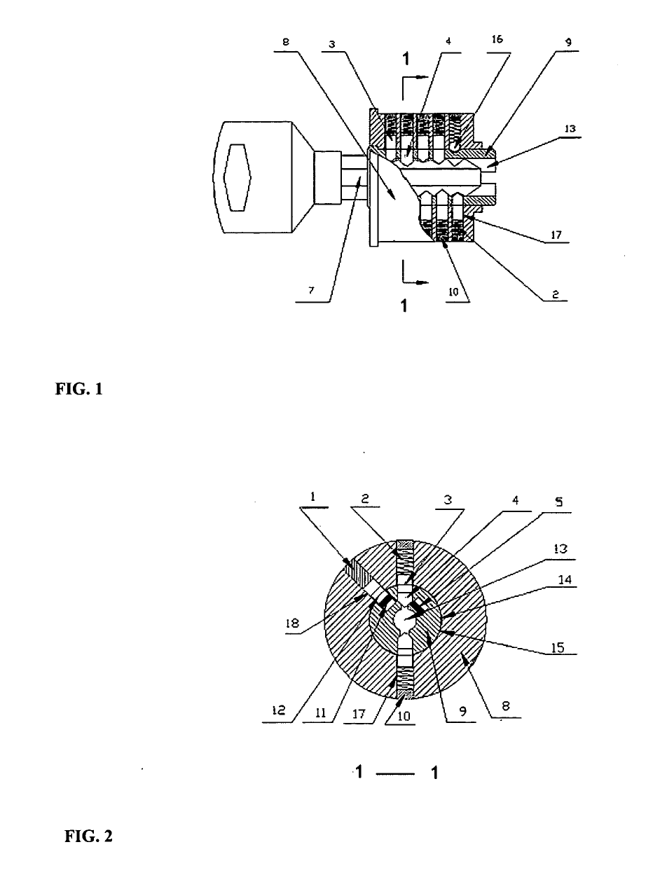

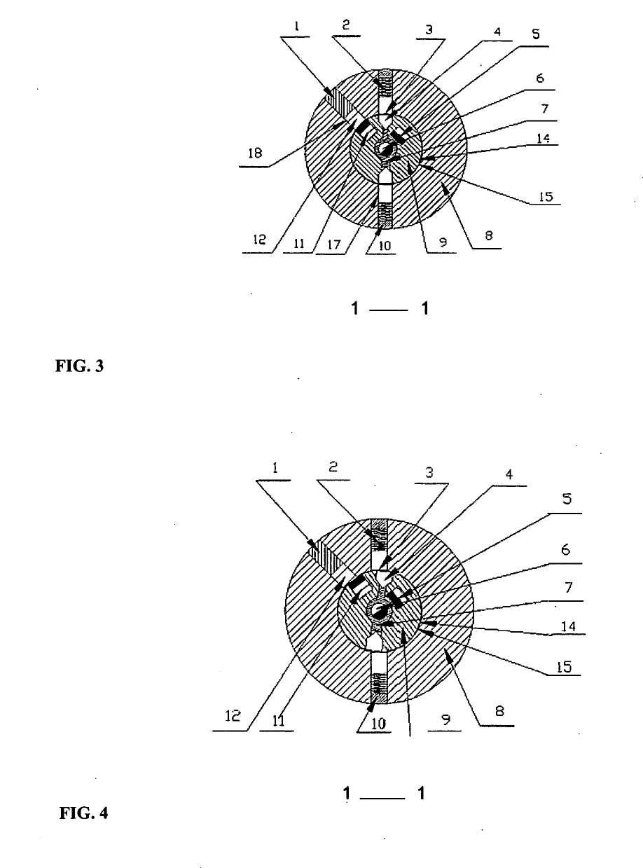

Referring the drawings for the purpose of illustration preferred embodiments of the present invention, the magnetic coded lock mechanism as shown in FIG. 1, FIG. 2, FIG. 3 and FIG. 4 comprises a cylindrical plug 9, a stationary tubular cylinder 8, a magnetic coded key 7, coil springs 2, key pins 4, driver pins 3, fixed permanent magnets 5 inside cylindrical plug 9, movable permanent magnets 11 and locking pins 12.

Longitudinal aperture disposed in the center of the cylindrical plug 9 is a keyway 13, which preferably is grooved to render it irregular whereby to require a key of particular cross-section for insertion into the keyway. Also provided in the cylindrical plug 9 are a plurality of radial extending main apertures open at the outer surface 14 of the cylindrical plug 9 to communicate with the shear plane of the tubular cylinder 8, and a plurality of radial auxiliary apertures which stop short of the outer surface 14 for housing the fixed permanent magnets 5.

Provided in the tubular cylinder 8 is a plurality or through apertures, which have the same longitudinal spacing as the cylindrical plug 9. Locking pins 12 and driver pins 3 are straddled between cylindrical plug 9 and tubular cylinder 8 which renders the,two groups of passages when the lock is in its locking position as shown in FIG. 2. At this time driver pins 3 are compressed down by spring force and moving magnets 11 are attracted by the biasing forces of fixed magnets 5.

As shown in FIG. 3, in an unlocked position, when the key 7 is inserted into the keyway, the recesses of the key drive ends of key pins 4, in return, push driver pins 3 and compress the coil springs 2. Simultaneously, the permanent magnets inside key 6 repel the movable magnets 11 since the poles of both magnets 6 and 11 are opposite to each other so that all the driver pins and locking pins are reached at the shear plane, causing the lock catch mechanism to be released.

As shown in FIG. 4, in a rotating position, all the locking pins are reached at the shear plane so that the cylindrical plug 9 is separated from tubular cylinder 8. Therefore, since the rotary plug can be rotated by itself, the lock mechanism is easily released.

The most important feature of the present invention is that the numbers, locations, orientations and poles of the permanent magnets 11 can be selected and placed on the cylindrical plug. This arrangement of the cylindrical plug 9 is set as a locking code for the magnetic lock mechanism. If the magnetic coded key 7 has the corresponding arrangement and pole of the cylindrical plug 9 and all the teeth are matched correctly, the magnetic key 7 is adapted for unlocking the lock assembly.

One of the main features of the present invention is anti-picking. Regardless the lock picking method, the objective is to lift each key pin so that all key pins are inside the lock plug and the driver pins are in the housing. In the present invention the movable magnets are not exposed to the keyway, therefore, no lifting force can be applied to move the magnetic locking pins.

Furthermore, “lock-bumping” poses a new and growing security threat to most conventional pin-tumbler locks. A specially cut key is positioned one notch out along the keyway. Bumping the key inward transmits kinetic energy from the key pins to split the bottom and top pins. As shown on FIG. 2 and FIG. 3 there is no physical contact point between key and magnetic locking pins. Therefore, no kinetic energy is transmitted so that the lock stays secure and bumping resistance is achieved.

Moreover, the total number of lock combinations of the present invention is described as N=Cm4. N is the total combination, C is conventional pin-tumbler lock comninaiton and m is pairs of embedded magnets (multiple pairs can be embeded). Therefore, when compared to conventional pin-tumbler locks, the present invention provides 4 m times as many locking permutations and combinations to ensure the secure functioning of the lock.

While only a limited number of the particular embodiments of this present invention have been disclosed herein, it does not in any way limit the applications of this invention, which may be varied in many ways. Such variations are not to be regarded as a departure from the spirit and scope of the invention, and all such modifications as would be obvious to one skilled in the art are intended to be included in the scope of the following claims.

1-16. (canceled)

17. A magnetic coded lock mechanism comprising:
(a) a key comprising a key body having a plurality of recesses and a plurality of magnets properly coded around said key body, and
(b) a cylindrical plug having a keyway aperture for receiving said key, a plurality of main apertures as first passages which include movable key pins, a plurality of auxiliary apertures as magnetic locking passages corresponding to said key, which contains movable magnets, a plurality of fixed magnets coded around said cylindrical plug, and
(c) a stationary tubular cylinder having a longitudinal aperture disposed in the center thereof for receiving said cylindrical plug, said tubular cylinder including a plurality of radial main apertures as second passages for mating with the main apertures of said cylindrical plug, each of said second passages including a driver pin with a coil spring, and radial auxiliary apertures as third passages for mating with the auxiliary apertures of said cylindrical plug, each of said third passages including a locking pin, wherein when said key is inserted into said keyway, said key recesses drive said key pins slidably disposed in main apertures of said cylindrical plug to a predetermined level and said movable magnets slidably disposed in auxiliary apertures of said cylindrical plug are repelled radially outward along said magnetic locking passages to a predetermined level respectively, so as to unlock said magnetic coded lock mechanism to enable said cylindrical plug to freely rotate to control the locking and unlocking of magnetic coded lock mechanism,
wherein at least one of the fixed magnets retracts the locking pin when the key is withdrawn.

18. The magnetic coded lock mechanism of claim 17, wherein said key is made of non-magnetic material.

19. The magnetic coded lock mechanism of claim 17, wherein said cylinder plug is made of non-magnetic material.

20. The magnetic coded lock mechanism of claim 17, wherein said movable magnets in said cylinder plug have magnetic poles opposite that of said key magnets for releasing said lock mechanism when said key is fully inserted into said keyway.

21. The magnetic coded lock mechanism of claim 17, wherein said magnets in said key have magnetic poles to repel movable magnets in said cylinder plug.

22. The magnetic coded lock mechanism of claim 17, wherein said stationary tubular cylinder is a hollow shell having an inner cylindrical surface and said movable cylindrical plug is a cylindrical plug rotatably movable within said shell.

23. The magnetic coded lock mechanism of claim 24, wherein said passages are radially extending from said cylindrical plug, and wherein said cylindrical plug includes a longitudinal keyway placed out of spatial communication with said passages.

24. The magnetic coded lock mechanism of claim 17, when in a locked position, wherein said key pins are disposed in said passages adjacent said keyway and said driver pins straddle both said passages to prevent relative movement between said cylindrical plug and said tubular cylinder.

25. The magnetic coded lock mechanism of claim 17, wherein said magnetic lock mechanism further comprises a bias device, and said bias device biases said key and driver pins toward said keyway.

26. The magnetic lock of claim 27, wherein said bias device is a spring to said shell in the vicinity of the passage therein.

27. The magnetic lock of claim 17, in a locked position, wherein said movable magnets disposed in said passages adjacent said keyway and said locking pins straddle both said passages to prevent relative movement between said cylindrical plug and tubular cylinder.

28. The magnetic coded lock mechanism of claim 17, wherein said magnetic lock mechanism further comprises a bias device, and said bias device biases said movable magnets and locking pins toward said keyway when said key is withdrawn.

29. The magnetic coded lock mechanism of claim 28, wherein said bias device is produced by said fixed magnets inside said cylindrical plug.

30. The magnetic lock of claim 28, wherein said bias device is a magnetic field that retracts the movable magnets and locking pins.

31. The magnetic lock of claim 28, wherein said locking pins are made of magnetic material.

32. A magnetic coded lock mechanism comprising:
a stationary outer cylinder device having stationary cylinder receiving apertures and a longitudinally disposed rotatable inner cylinder device;
a coded magnetic pin device slidably disposed in pin receiving apertures arranged around said inner cylinder device;
a keyway device provided in said inner cylinder device situated out of spatial communication With said stationary cylinder receiving apertures; and a stationary magnet device disposed in said inner cylinder device for returning said moving magnetic device radially inwards to the base of said pin receiving aperture to prevent relative movement between said rotatable inner cylinder device;
a tumbler mechanism bestridden said rotatable inner cylinder device and stationary outer cylinder device to prevent relative movement between said inner and outer cylinder devices;
a catch device provided on said stationary outer cylinder device for communicating with said magnetic pin and said driver and a key pin device for selectively locking and unlocking said relative rotation between said inner cylinder device;
a magnetic coded key device paired for reception in said keyway and having a magnetic device defining a plurality of polar axes oriented such that when said key means has been inserted in said keyway devices said tumbler mechanism device is biased by said key devices and said polar axes of said key device is disposed with polar repulsion to said polar axes of said magnetic pin devices and with greater repulsion than the concerted magnetic forces of said stationary magnet device on said magnetic pin device for causing said magnetic pin device to slide radially outwards in said receiving aperture, whereby said drive pin, key pin, and magnetic pin devices are withdrawn from said catch device to unlock said stationary outer and rotatable inner cylinder device for allowing relative rotation therebetween,
wherein at least one of the fixed magnets retracts the locking pin when the key is withdrawn.
